(19) United States
(12) Patent Application Publication
(10) Pub. No.: US 2026/0061749 A1
(43) Pub. Date: Mar. 5, 2026

(54) LIQUID EJECTING APPARATUS

(71) Applicant: BROTHER KOGYO KABUSHIKI KAISHA, Nagoya (JP)

(72) Inventors: Motoki YAMADA, Nagoya (JP); Hiroya OKUWA, Tajimi (JP); Rui WANG, Nagoya (JP); Mikio HIRANO, Okazaki (JP); Tatsuya MIYASAKA, Nagoya (JP)

(73) Assignee: BROTHER KOGYO KABUSHIKI KAISHA, Nagoya (JP)

(21) Appl. No.: 19/292,058

(22) Filed: Aug. 6, 2025

(30) Foreign Application Priority Data
Aug. 30, 2024 (JP) 2024-148362

(51) Int. Cl. B41J 2/165; B41J 2/21; B41J 11/00; C09D 11/30; C09D 11/54

(52) U.S. Cl. CPC B41J 2/16508; B41J 2/2117; B41J 11/0015; C09D 11/30; C09D 11/54; B41J 2002/16594; B41P 2235/27

(57) ABSTRACT

A liquid ejecting apparatus includes a switching valve having an outlet port and inlet ports, and switching, among channels, a channel to be communicated with the outlet port. The channels include: a first liquid-draining channel connecting a treatment liquid head and the switching valve, treatment liquid discharged to a treatment liquid cap flowing therethrough; a second liquid-draining channel connecting an ink head and the switching valve, ink discharged to an ink cap flowing therethrough; a first cleaning liquid-supplying channel connecting a cleaning liquid tank to the switching valve via the treatment liquid cap; a second cleaning liquid-supplying channel connecting the cleaning liquid tank to the switching valve via the ink cap; and a cleaning liquid bypass channel connecting the cleaning liquid tank to the switching valve not via the treatment liquid and ink caps.

### REFERENCE TO RELATED APPLICATIONS

This application claims priority from Japanese Patent Application No. 2024-148362 filed on Aug. 30, 2024. The entire content of the priority application is incorporated herein by reference.

### BACKGROUND ART

A known liquid ejecting apparatus includes a switching valve which communicates a suction pump with a cap port communicating with a nozzle cap, in a standby state wherein printing, etc., is not performed. In this liquid ejecting apparatus, in a case where determination is made that a channel member adheres to a cover due to ink solidified inside the switching valve, the suction pump is driven to discharge ink inside the ink-jet head and to cause the discharged ink to flow into the switching valve.

### SUMMARY

In the above-described configuration, before the ink is ejected to a print medium, a pre-treatment liquid is ejected in advance to improve the fixability of the ink with respect to the print medium, in some cases. However, in a case where the ink purged and drained as waste liquid contacts the pre-treatment liquid in a channel including the switching valve, the ink might solidify and interfere with the operation of the pump while the ink is being purged and drained.

In view of the above-described situation, the present disclosure aims to provide a liquid ejecting apparatus capable of reducing the solidification of ink due to contact between the ink and a treatment liquid in a channel including, for example, a channel switching mechanism.

A liquid ejecting apparatus according to an aspect of the present disclosure includes: a treatment liquid head having a treatment liquid nozzle plate, the treatment liquid nozzle plate having treatment liquid nozzle holes, treatment liquid being ejected from the treatment liquid nozzle holes, the treatment liquid including one of pre-treatment liquid, post-treatment liquid, or both the pre-treatment liquid and the post-treatment liquid; an ink head having an ink nozzle plate, the ink nozzle plate having ink nozzle holes, ink being ejected from the ink nozzle holes, the ink including one of white ink, color ink, or both the white ink and the color ink; a treatment liquid cap, a treatment liquid nozzle surface as a surface of the treatment liquid nozzle plate being covered by the treatment liquid cap; an ink cap, an ink nozzle surface as a surface of the ink nozzle plate being covered by the ink cap; a cleaning liquid tank; a plurality of channels; and a channel switching mechanism including a switching valve having an outlet port and a plurality of inlet ports, a channel to be communicated with the outlet port being switched by the channel switching mechanism among the plurality of channels. The plurality of channels includes: a first liquid-draining channel connecting the treatment liquid head and the switching valve, the treatment liquid discharged to the treatment liquid cap flowing through the first liquid-draining channel; a second liquid-draining channel connecting the ink head and the switching valve, the ink discharged to the ink cap flowing through the second liquid-draining channel; a first cleaning liquid-supplying channel connecting the cleaning liquid tank to the switching valve via the treatment liquid cap; a second cleaning liquid-supplying channel connecting the cleaning liquid tank to the switching valve via the ink cap; and a cleaning liquid bypass channel connecting the cleaning liquid tank to the switching valve not via the treatment liquid cap and the ink cap.

According to the present disclosure, cleaning liquid is supplied from the cleaning liquid tank to the switching valve via the cleaning liquid bypass channel, not via the treatment liquid cap and the ink cap. Thus, the ink and the treatment liquid which are present in the switching valve and the pump connected to the switching valve via a tube can be easily diluted by the cleaning liquid supplied from the cleaning liquid tank directly to the switching valve. With this, the solidification of the ink due to the contact between the ink and the treatment liquid in the channel including, for example, the switching valve can be reduced.

According to the present disclosure, the liquid ejecting apparatus capable of reducing the solidification of the ink due to the contact between the ink and the treatment liquid in the channel including, for example, the channel switching mechanism can be provided.

### BRIEF DESCRIPTION OF DRAWINGS

FIG. 1 is a plan view depicting a liquid ejecting apparatus according to an embodiment.

FIG. 2 is a block diagram depicting the configuration of a control system of the liquid ejecting apparatus depicted in FIG. 1.

FIG. 3A is a view depicting a capped state of each of heads, and FIG. 3B is a view depicting an uncapped state of each of the heads.

FIG. 4 is a perspective view depicting the configuration of a switching valve.

FIG. 5A is a view depicting a first liquid-draining channel during purging of a pre-treatment liquid head, FIG. 5B is a view depicting a first cleaning liquid-supplying channel during cleaning of the pre-treatment liquid head, and FIG. 5C is a view depicting a suction channel during idle suction of the pre-treatment liquid head.

FIG. 6A is a view depicting a second liquid-draining channel during purging of a white ink head, FIG. 6B is a view depicting a second cleaning liquid-supplying channel during cleaning of the white ink head, and FIG. 6C is a view depicting a suction channel during idle suction of the white ink head.

FIG. 7A is a view depicting a cleaning liquid bypass channel during cleaning of the switching valve, and FIG. 7B is a view depicting a suction channel during idle suction of the cleaning liquid bypass channel.

FIG. 8 is a flowchart depicting the flow of a maintenance process for the pre-treatment liquid head and an ink head.

FIG. 9 is a flowchart depicting the flow of a maintenance process for the ink head and a post-treatment liquid head.

FIG. 10 is a view depicting an aspect in which a carriage supports the pre-treatment liquid head, the white ink head, a color ink head, and the post-treatment liquid head.

FIG. 11A is a view depicting an ejecting head, a treatment liquid cap and an ink cap which correspond to the ejecting head, and FIG. 11B is a view depicting an ejecting head, and a cap which corresponds to the ejecting head.

### DESCRIPTION

A liquid ejecting apparatus according to an embodiment of the present disclosure will be described below, with reference to the drawings. The liquid ejecting apparatus described below is merely an embodiment of the present disclosure. Therefore, the present disclosure is not limited to the following embodiment, and a configuration can be added, deleted, or changed within the scope of the disclosure. Note that in the following description, the same reference numerals are affixed to the same or corresponding elements throughout all the drawings, and any overlapping description therefor will be omitted unless otherwise noted.

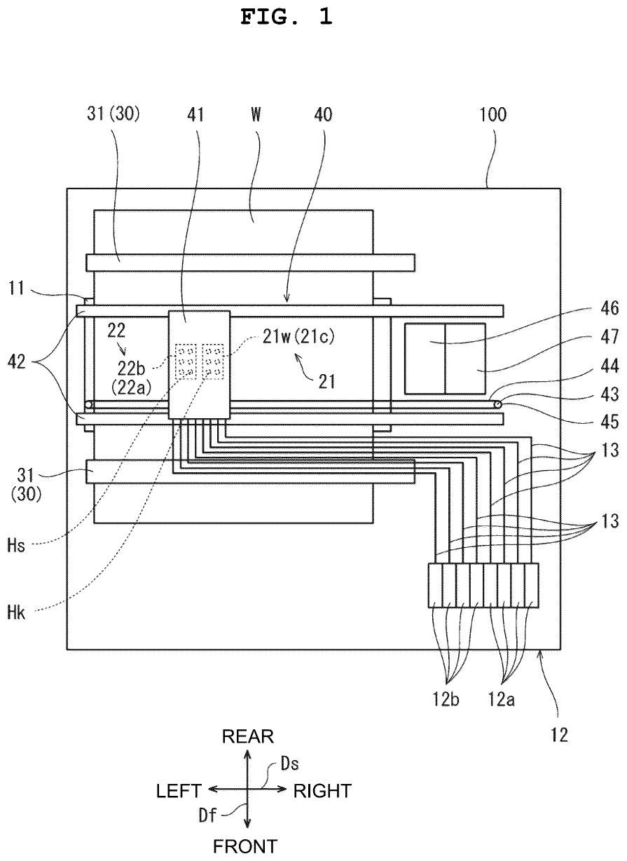

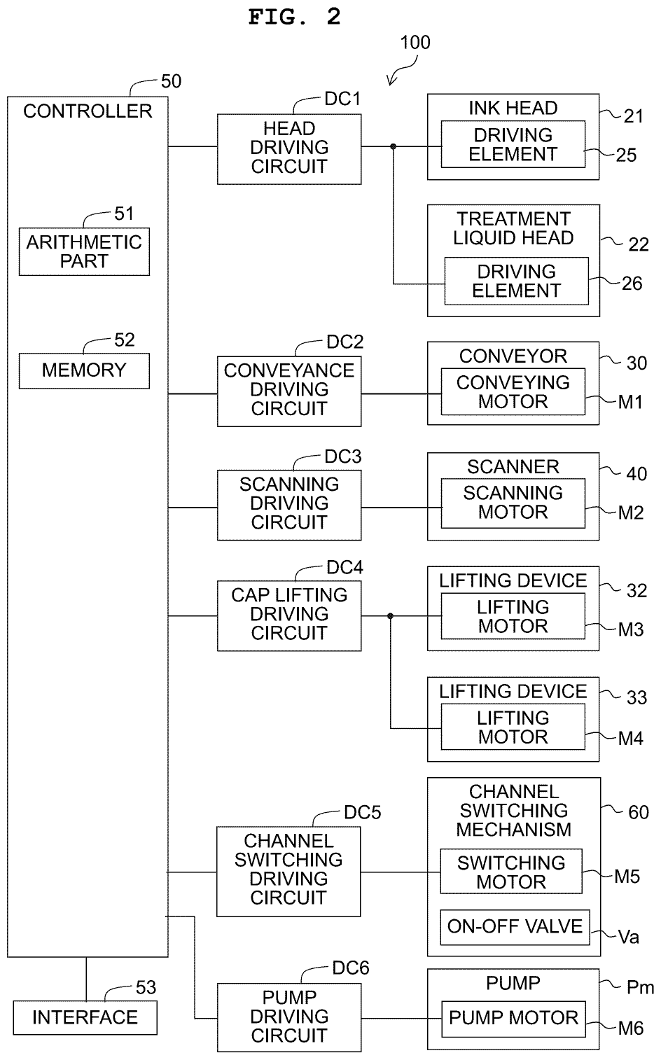

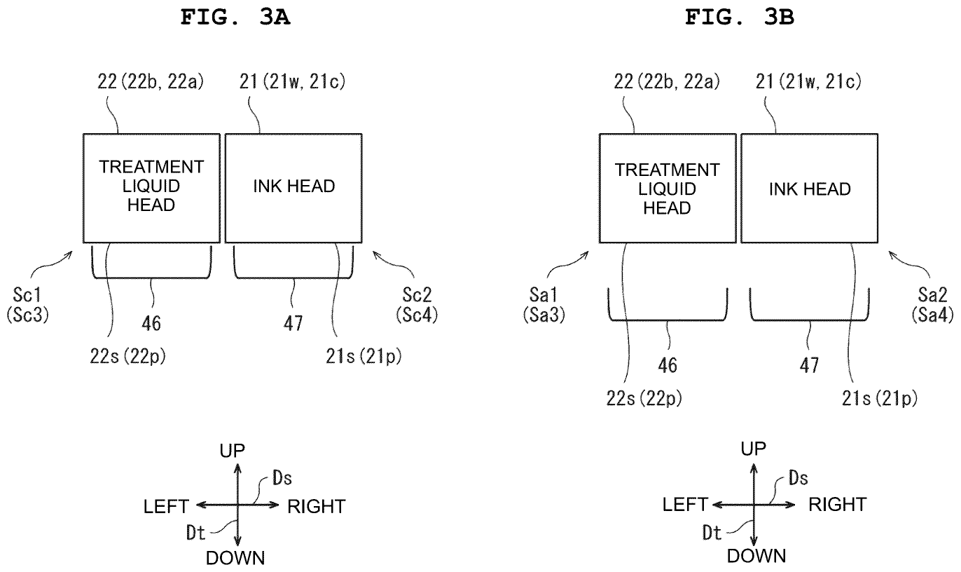

FIG. 1 is a plan view depicting a liquid ejecting apparatus 100 according to the embodiment. FIG. 2 is a block diagram depicting the configuration of a control system of the liquid ejecting apparatus 100 depicted in FIG. 1. FIG. 3A is a view depicting a capped state of a treatment liquid head 22 and an ink head 21, and FIG. 3B is a view depicting an uncapped state of the treatment liquid head 22 and the ink head 21. In FIG. 1, FIG. 3, etc., mutually orthogonal directions are referred to as a first direction Df, a second direction Ds, and a third direction Dt. In the present embodiment, for example, the first direction Df is a conveying direction of a recording medium W, the second direction Ds is a moving direction of a carriage 41 to be described later, and the third direction Dt is the up-down direction. In the following description, the second direction Ds is referred to as the moving direction Ds, the first direction Df is referred to as the conveying direction Df, and the third direction Dt is referred to as the up-down direction Dt. However, the above-described directions are examples and do not limit the present disclosure.

As depicted in FIG. 1, the liquid ejecting apparatus 100 is applied, for example, to an ink-jet printer which prints an image on the recording medium W, such as a printing sheet. The liquid ejecting apparatus 100 ejects, to the recording medium W, ink or treatment liquid supplied from a tank 12 as liquid. The details of the ink and treatment liquid will be described later.

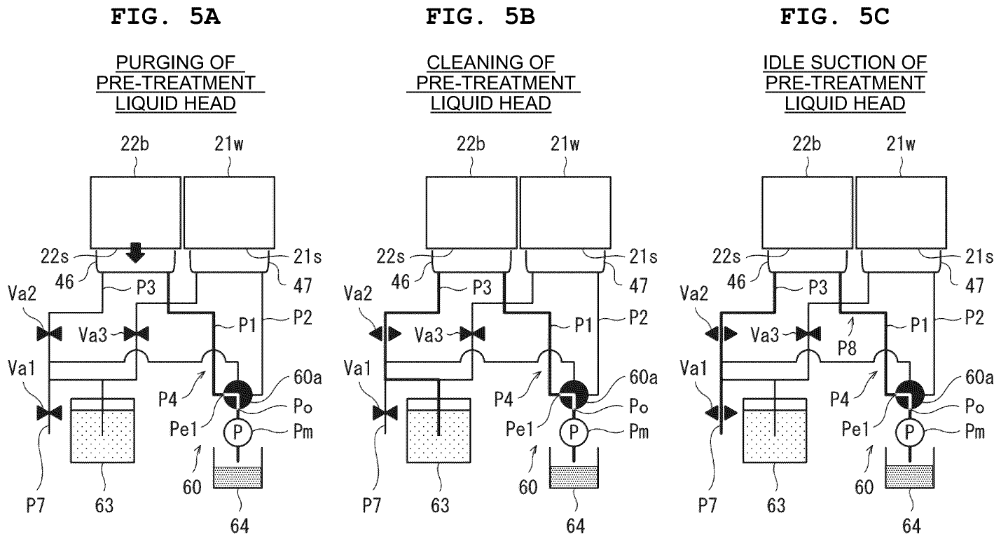

The liquid ejecting apparatus 100 is, for example, of a serial head type. The liquid ejecting apparatus 100 includes a platen 11, a plurality of tanks 12, an ink head 21, a treatment liquid head 22, a conveyor 30, a scanner 40, a treatment liquid cap 46, an ink cap 47, a cleaning liquid tank 63 (see FIG. 5 to be described later), and a waste liquid tank 64 (see FIG. 5 to be described later). Note that the liquid ejecting apparatus 100 may also be of a line head type.

The ink head 21 ejects the ink to the recording medium W. Specifically, the ink head 21 ejects ink including one of white ink, color ink, or both the white ink and the color ink. Cyan ink, yellow ink, magenta ink, and black ink are examples of the color ink. In the example depicted in FIG. 1, the ink head 21 is a white ink head 21w which ejects the white ink as the ink. The white ink head 21w ejects the white ink to a part, of the recording medium W, to which a pre-treatment liquid head 22b which will be described later has ejected pre-treatment liquid. Note that the ink head 21 may also be a color ink head 21c which ejects the color ink as the ink. Both the white ink head 21w and the color ink head 21c may be included in the liquid ejecting apparatus 100. In other words, both the white ink head 21w and the color ink head 21c may be disposed as the ink head 21. In the following, in a case where reference is made regarding the ink head 21, both the white ink head 21w and the color ink head 21c are to be included.

The treatment liquid head 22 ejects the treatment liquid to the recording medium W. Specifically, the treatment liquid head 22 ejects treatment liquid including one of pre-treatment liquid, post-treatment liquid, or both the pre-treatment liquid and the post-treatment liquid. In the example depicted in FIG. 1, the treatment liquid head 22 is a pre-treatment liquid head 22b which ejects the pre-treatment liquid as the treatment liquid. The pre-treatment liquid head 22b ejects the pre-treatment liquid before the ink such as the white ink is ejected to the recording medium W. Note that the treatment liquid head 22 may be a post-treatment liquid head 22a which ejects the post-treatment liquid as the treatment liquid. In this case, the post-treatment liquid head 22a ejects the post-treatment liquid to a part, of the recording medium W, to which the color ink has been ejected. Both the pre-treatment liquid head 22b and the post-treatment liquid head 22a may be included in the liquid ejecting apparatus 100. In other words, both the pre-treatment liquid head 22b and the post-treatment liquid head 22a may be disposed as the treatment liquid head 22. In the following, in a case where reference is made regarding the treatment liquid head 22, both the pre-treatment liquid head 22b and the post-treatment liquid head 22a are to be included.

As depicted in FIGS. 3A and 3B, the ink head 21 has an ink nozzle plate 21p. The ink nozzle plate 21p has ink nozzle holes Hk (FIG. 1). The ink nozzle holes extend through the ink nozzle plate 21p. The ink is ejected from the ink nozzle holes Hk. The ink head 21 has an ink nozzle surface 21s which is a surface of the nozzle plate 21p. Further, the treatment liquid head 22 has a treatment liquid nozzle plate 22p. The treatment liquid nozzle plate 22p has treatment liquid nozzle holes Hs (FIG. 1). The treatment nozzle holes extend through the treatment liquid nozzle plate 22p. The treatment liquid is ejected from the treatment liquid nozzle holes Hs. The treatment liquid head 22 has a treatment liquid nozzle surface 22s which is a surface of the treatment liquid nozzle plate 22p.

Each of the white ink and the color ink is, for example, water-based ink, and contains resin fine particles, colorant, organic solvent, surfactant, and water. In the present embodiment, each of the white ink and the color ink contains a solid content; the solid content includes resin fine particles and a solid content of the colorant. For example, the resin fine particles are contained in each of the white ink and the color ink in a range of 0.1 wt % to 30 wt %, and the solid content of the colorant is contained in each of the white ink and the color ink in a range of 0.1 wt % to 20 wt %. The viscosity of each of the white ink and the color ink is higher than the viscosity of cleaning liquid which will be described later. Note that as the resin fine particles, for example, resin fine particles containing one of methacrylic acid, acrylic acid, or both the methacrylic acid and the acrylic acid as a monomer can be used. As the resin fine particles, for example, a commercially available product can be used. The resin fine particles may also contain, for example, styrene, vinyl chloride, etc., as the monomer. The resin fine particles may be, for example, resin fine particles contained in emulsion. Further, the average particle diameter of the resin fine particles is, for example, in a range of 30 nm to 200 nm.

The pre-treatment liquid is solution in accordance with the kind of the ink such as the white ink and the kind of the recording medium W, and is exemplified, for example, by aqueous solution containing a polyvalent metal salt, and is used for pre-treatment before printing. Further, the post-treatment liquid is liquid in accordance with the kind of the ink such as the color ink and the kind of the recording medium W, and is exemplified, for example, by aqueous solution containing resin, and is used for post-treatment after printing.

The platen 11 has a flat upper surface and defines the distance between the recording medium W placed on the upper surface and the lower surface of the ink head 21 and the lower surface of the treatment liquid head 22 disposed to face the print medium W. The plurality of tanks 12 is connected to the ink head 21 and treatment liquid head 22 via a tube 13. The plurality of tanks 12 includes a plurality of first tanks 12a and a plurality of second tanks 12b. A first tank or tanks 12a as a part of the plurality of first tanks 12 stores the white ink, and first tanks 12a as the remainder of the plurality of first tanks 12b store the cyan, yellow, magenta and black inks included in the above-described color inks. Further, a second tank or tanks 12b as a part of the plurality of second tanks 12b stores the pre-treatment liquid, and second tanks 12b as the remainder of the plurality of second tanks 12b store the post-treatment liquid. Note that the plurality of tanks 12 may also store special color ink(s), such as red ink, green ink, and blue ink which are different from the colors of the above-described white ink and the color inks. Furthermore, another ink head, different from the ink head 21 and the treatment liquid head 22 and configured to eject the special color ink(s), may be further included in the liquid ejecting apparatus 100.

The conveyor 30 has, for example, two sets of conveying rollers 31 and a conveying motor M1 (see FIG. 2). The two sets of conveying rollers 31 are disposed so that the platen 11 is interposed between the two sets of conveying rollers 31 in the transport direction Df. Each of the two sets of conveying rollers 31 is constructed as a roller pair, and disposed so that the recording medium W is interposed between one roller and the other roller of the roller pair. The one roller of each of the two sets of the conveying rollers 31 is connected to the conveying motor M1. The conveying rollers 31 are rotated by the rotational motion of the conveying motor M1 so as to convey the recording medium W on the platen 11 in the conveying direction Df.

The scanner 40 has a carriage 41, two guide rails 42, a scanning motor M2 (see FIG. 2), and an endless belt 44. The two guide rails 42 extend in the moving direction Ds at a location above the platen 11 so that the white ink head 21w and the pre-treatment liquid head 22b are interposed between the two guide rails 42 in the conveying direction Df. The carriage 41 supports the white ink head 21w and the pre-treatment liquid head 22b, as depicted in FIG. 1. The carriage 41 is supported by the two guide rails 42 to be movable in the moving direction Ds. The endless belt 44 extends in the moving direction Ds, is connected to the carriage 41, and is attached to the scanning motor M2 via a pulley 45. In a case where the scanning motor M2 rotates, the endless belt 44 is activated to cause the carriage 41 to reciprocate along the two guide rails 42 in the moving direction Ds. This causes the white ink head 21w and the pre-treatment liquid head 22b to reciprocate in the moving direction Ds by the carriage 41. In a case where the color ink head 21c and the post-treatment liquid head 22a are additionally disposed in the carriage 41, the carriage 41 supports the color ink head 21c and the post-treatment liquid head 22a, in addition to the white ink head 21w and the pre-treatment liquid head 22b.

The treatment liquid cap 46 covers the treatment liquid nozzle surface 22s of the treatment liquid head 22. The ink cap 47 covers the ink nozzle surface 21s of the ink head 21. In other words, the treatment liquid cap 46 covers the treatment liquid nozzle surface 22s which is a surface of the treatment liquid nozzle plate 22p. The ink cap 47 covers the ink nozzle surface 21s which is a surface of the ink nozzle plate 21p. A covering process for the treatment liquid cap 46 and the ink cap 47 will be described later.

As depicted in FIG. 2, the liquid ejecting apparatus 100 includes a controller 50, an interface 53, a head driving circuit DC1, a conveyance driving circuit DC2, a scanning driving circuit DC3, a cap lifting driving circuit DC4, a channel switching driving circuit DC5, and a pump driving circuit DC6. The liquid ejecting apparatus 100 further includes a lifting device 32, a lifting device 33, a channel switching mechanism 60, and a suction pump Pm. In the present embodiment, the lifting device 32 corresponds to a first switching mechanism, and the lifting device 33 corresponds to a second switching mechanism.

The controller 50 corresponds to a computer, and has an arithmetic part 51 and a memory 52. The controller 50 may be constructed of a single device, or the controller 50 may be constructed of a plurality of devices dispersed in the liquid ejecting apparatus 100 and configured to operate together so as to perform operations of the liquid ejecting apparatus 100.

The arithmetic part 51 includes at least one circuit which is, for example, a processor such as a CPU, and an integrated circuit such as an ASIC. The arithmetic part 51 controls each part of the liquid ejecting apparatus 100 by executing a predetermined program and executes various operations, such as a liquid ejecting operation.

The memory 52 is a memory accessible from the arithmetic part 51 and has RAM and ROM. The RAM temporarily stores various data, such as image data received from an external device and data converted by the arithmetic part 51. The ROM stores a printing program and predetermined data for performing various kinds of data processing. Note that the program may be stored in a storage medium, such as CD-ROM, which is an external storage medium different from the memory 52 and accessible from the arithmetic part 51. A program stored in the storage medium may be read via a reading device and executed by the arithmetic part 51.

The interface 53 receives various data, such as the image data from the external device such as a computer, a camera, a communication network, a display, and a printer. The image data is raster data, etc., indicating an image to be printed on the recording medium W, and includes, for example, information on a print condition including the kind of the recording medium W.

The ink head 21 has a driving element 25. The treatment liquid head 22 has a driving element 26. The driving element 25 is, for example, a piezoelectric element, a heat-generating element, an electrostatic actuator, and is disposed on a corresponding one of the ink nozzle holes Hk and applies pressure to the ink to eject the ink from the corresponding one of the ink nozzle holes Hk. The driving element 26 is, for example, a piezoelectric element, a heat-generating element, and an electrostatic actuator, and is disposed on a corresponding one of the treatment liquid nozzle holes Hs and applies pressure to the treatment liquid to eject the treatment liquid from the corresponding one of the treatment liquid nozzle holes Hs.

The head driving circuit DC1 controls the operation of each of the driving element 25 and the driving element 26 based on an instruction from the controller 50. The driving element 25 applies a predetermined ejecting energy to the ink in the ink head 21. With this, the ink is ejected. Further, the driving element 26 applies a predetermined ejecting energy to the treatment liquid in the treatment liquid head 22. With this, the treatment liquid is ejected.

The conveyance driving circuit DC2 controls the operation of the conveying motor M1 of the conveyor 30, based on an instruction from the controller 50. The conveying motor M is activated to thereby cause the platen 11 to convey the print medium M intermittently or continuously along the conveying direction Df and to further cause the recording medium W to stop at a predetermined position in the conveying direction Df.

The scanning driving circuit DC3 controls the operation of the scanning motor M2 of the scanner 40, based on an instruction from the controller 50. The scanning motor M2 is activated to thereby cause the carriage 41 to reciprocate in the moving direction Ds. This causes the white ink head 21w and the pre-treatment liquid head 22b to reciprocate in the moving direction Ds.

The lifting device 32 has a lifting motor M3. The lifting motor M3 is connected to the treatment liquid cap 46 via a driving mechanism including, for example, a non-illustrated ball screw or rack and pinion. The cap lifting driving circuit DC4 controls the operation of the lifting motor M3 of the lifting device 32, based on an instruction from the controller 50. The lifting motor M3 is activated to thereby lift and lower the treatment liquid cap 46. In a case where the treatment liquid head 22 is the pre-treatment liquid head 22b, the lifting device 32 performs switching between a first capped state Sc1 as depicted in FIG. 3A and a first uncapped state Sa1 as depicted in FIG. 3B by lifting and lowering the treatment liquid cap 46. In the first capped state Sc1, the treatment liquid nozzle surface 22s of the pre-treatment liquid head 22b is covered by the treatment liquid cap 46, whereas in the first uncapped state Sa1, the treatment liquid nozzle surface 22s of the pre-treatment liquid head 22b is not covered by the treatment liquid cap 46. Note that in a case where the treatment liquid head 22 is the post-treatment liquid head 22a, the lifting device 32 performs switching between a third capped state Sc3 as depicted in FIG. 3A and a third uncapped state Sa3 as depicted in FIG. 3B. In the third capped state Sc3, the treatment liquid nozzle surface 22s of the post-treatment liquid head 22a is covered by the treatment liquid cap, whereas in the third uncapped state Sa3, the treatment liquid nozzle surface 22s of the post-treatment liquid head 22a is not covered by the treatment liquid cap 46.

Further, the lifting device 32 has a lifting motor M4. The lifting motor M4 is connected to the ink cap 47 via a driving mechanism including, for example, a non-illustrated ball screw or rack and pinion. The cap lifting driving circuit DC4 controls the operation of the lifting motor M4 of the lifting device 33, based on an instruction from the controller 50. The lifting motor M4 is activated to thereby lift and lower the ink cap 47. In a case where the ink head 21 is the white ink head 21w, the lifting device 33 performs switching between a second capped state Sc2 and a second uncapped state Sa2 by lifting and lowering the ink cap 47. In the second capped state Sc2, the ink nozzle surface 21a of the white ink head 21w is covered by the ink cap 47, whereas in the second uncapped state Sa2, the ink nozzle surface 21s of the white ink head 21w is not covered by the ink cap 47. Note that in a case where the ink head 21 is the color ink head 21c, the lifting device 33 performs switching between a fourth capped state Sc4 as depicted in FIG. 3A and a fourth uncapped state Sa4 as depicted in FIG. 3B. In the fourth capped state Sc4, the ink nozzle surface 21s of the color ink head 21c is covered by the ink cap 47, whereas in the fourth uncapped state Sa4, the ink nozzle surface 21s of the color ink head 21c is not covered by the ink head 47. Note that in the present embodiment, although the treatment liquid cap 46 and the ink cap 47 are lifted and lowered, respectively, by the different lifting devices 32 and 33, the present disclosure is not limited to this. The treatment liquid cap 46 and the ink cap 47 may be lifted and lowered by a common lifting device. In this case, the states of the treatment liquid cap 46 and the ink cap 47 are switched to the capped state or the uncapped state at the same timing.

The channel switching driving circuit DC5 controls the operation of a switching motor M5 included in the channel switching mechanism 60, based on an instruction from the controller 50. Further, the channel switching driving circuit DC5 controls an opening-closing operation of an on-off valve Va included in the channel switching mechanism 60, based on an instruction from the controller 50. The pump switching driving circuit DC6 controls the operation of a pump motor M6 included in the pump Pm, based on an instruction from the controller 50. Note that the channel switching mechanism 60 and the pump Pm will be described in detail later.

The controller 50 obtains the image data and executes a printing operation, which is the liquid ejecting operation, based on the image data. In a printing pass of the printing operation, the controller 50 causes the ink head 21 to move in the movement direction Ds while causing the ink head 21 to eject the ink to the print medium W. Then, in a conveying operation of the printing operation, the controller 50 causes the recording medium W to move forward in the conveying direction Df. In such a manner, the controller 50 repeats the printing pass and the conveying operation alternately. With this, an image regarding the image data is printed on the recording medium W.

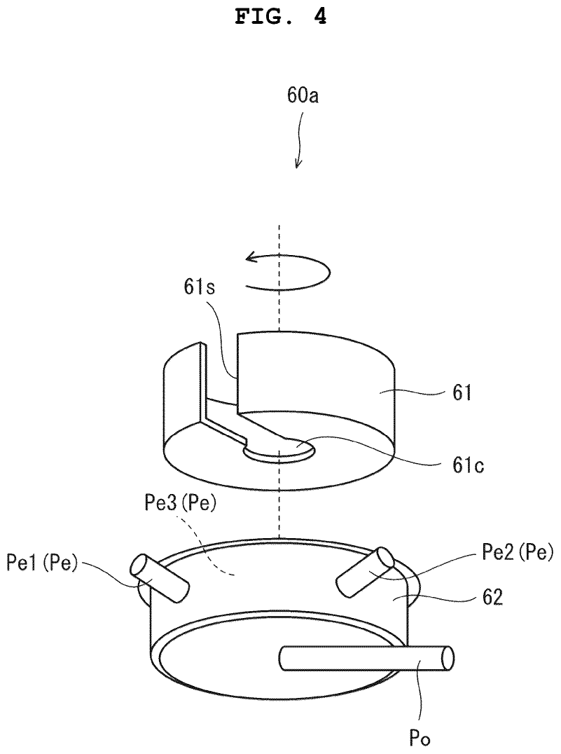

FIG. 4 is a perspective view depicting the configuration of a switching valve 60a. FIG. 5A is a view depicting a first liquid-draining channel P1 during purging of the pre-treatment liquid head 22b, FIG. 5B is a view depicting a first cleaning liquid-supplying channel P4 during cleaning of the pre-treatment liquid head, and FIG. 5C is a view depicting a suction channel P8 during idle suction of the pre-treatment liquid head 22b.

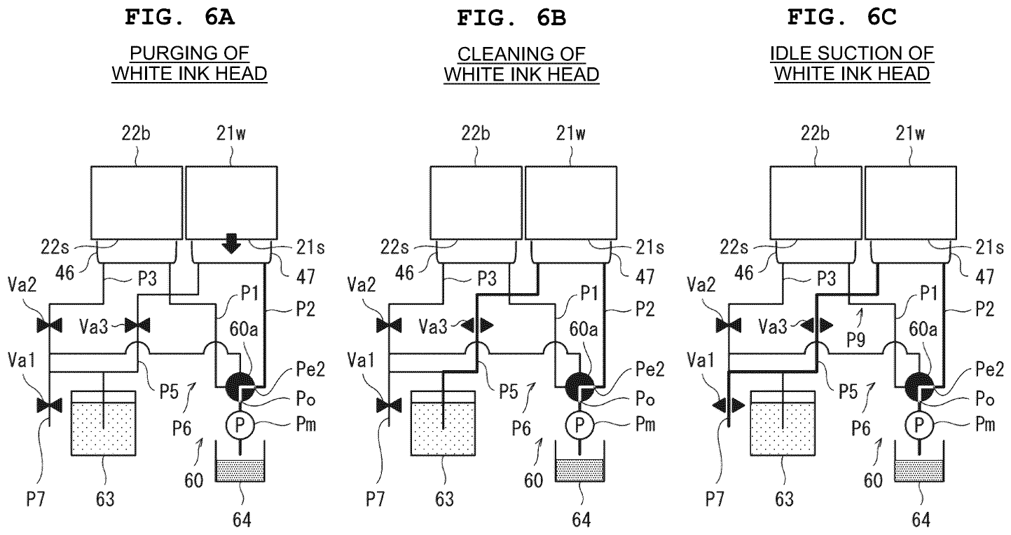

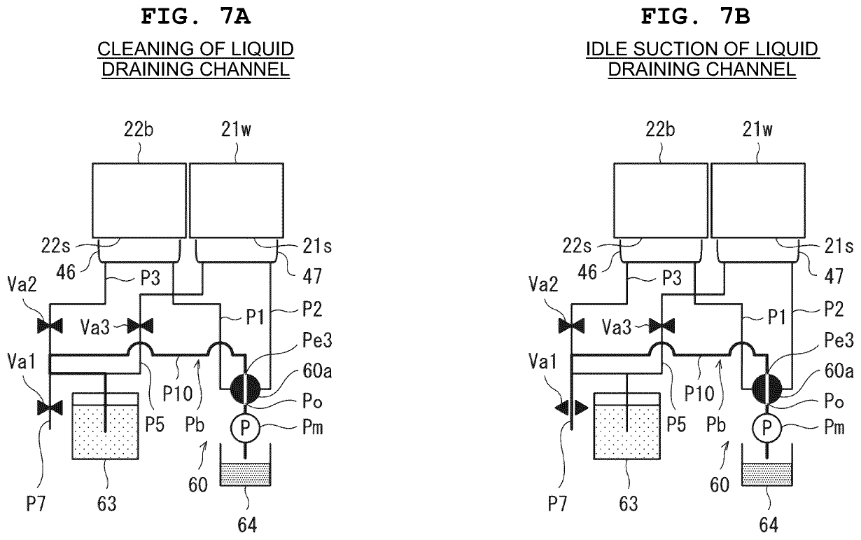

Further, FIG. 6A is a view depicting a second liquid-draining channel P2 during purging of the white ink head 21w, FIG. 6B is a view depicting a second cleaning liquid-supplying channel P6 during cleaning of the white ink head 21w, and FIG. 6C is a view depicting a suction channel P9 during idle suction of the white ink head 21w. Furthermore, FIG. 7A is a view depicting a cleaning liquid bypass channel Pb during cleaning of the switching valve 60a, and FIG. 7B is a view depicting a suction channel during idle suction of the cleaning liquid bypass channel Pb.

The liquid ejecting apparatus 100 of the present embodiment includes the channel switching mechanism 60, the cleaning liquid tank 63, the waste liquid tank 64, the first liquid-draining channel P1, the first cleaning liquid-supplying channel P4, the suction channel P8, the second liquid-draining channel P2, the second cleaning liquid-supplying channel P6, the suction channel P9, and the cleaning liquid bypass channel Pb, as described above and as depicted in FIG. 5A, etc. The channel switching mechanism 60 has the switching valve 60a, an on-off valve Va1, an on-off valve Va2, an on-off valve Va3, and the above-described switching motor M5. In the present embodiment, the first liquid-draining channel P1, the second liquid-draining channel P2, the first cleaning liquid-supplying channel P4, the second cleaning liquid-supplying channel P6, and the cleaning liquid bypass channel Pb correspond to a plurality of channels.

The channel switching mechanism 60 includes the switching valve 60a depicted in FIG. 4 and having an outlet port Po and a plurality of inlet ports Pe. The channel switching mechanism 60 switches a channel to be connected to the outlet port Po among the plurality of channels described above.

The switching valve 60a has, for example, a rotary member 61 having a shape of a bottomed cylinder, and a stationary member 62 having a shape of a bottomed cylinder. The rotary member 61 is inserted coaxially into the stationary member 62. FIG. 4 depicts a state that the rotary member 61 is separated from the stationary member 62 so that the drawing can be easily understood. The rotary member 61 has a slit 61s extending in the axial direction and defined in the peripheral wall of the rotary member 61. Further, the rotary member 61 has a slit 61c extending in the radial direction and defined in the bottom part of the rotary member 61. The slit 61s and the slit 61c are connected. The rotary member 61 is connected to the switching motor M5.

The outlet port Po and the plurality of inlet ports Pe as described above are disposed in the stationary member 62. The plurality of inlet ports Pe includes a first inlet port Pe1, a second inlet port Pe2, and a third inlet port Pe3. The first inlet port Pe1, the second inlet port Pe2, and the third inlet port Pe3 are disposed on the circumferential wall of the stationary member 62. The first inlet port Pe1, the second inlet port Pe2, and the third inlet port Pe3 are located at predetermined intervals in the circumferential direction of the stationary member 62. On the other hand, the outlet port Po is disposed in the bottom part of the stationary member 62.

In the above-described configuration, the switching motor M5 is activated to thereby rotate the rotary member 61 about the axis of rotation relative to the stationary member 62. The rotary member 61 rotates at a predetermined rotation angle to thereby cause the slit 61s of the rotary member 61 to be connected to one of the first inlet port Pe1, the second inlet port Pe2 and the third inlet port Pe3. With this, the inlet port Pe, as one of the first inlet port Pe1, the second inlet port Pe2 and the third inlet port Pe3 and to which the slit 61s is connected, is connected to the outlet port Po via the slit 61s and the slit 61c. With this, for example, the cleaning liquid flowing from the inlet port Pe into the switching valve 60a is caused to flow out of the outlet port Po, as will be described later.

The cleaning liquid tank 63 stores the cleaning liquid for cleaning the treatment liquid nozzle surface 22s and the ink nozzle surface 21s. In the present embodiment, the cleaning liquid does not contain a solid content. The cleaning liquid is a liquid capable of cleaning (diluting) the ink and includes, for example, organic solvent, surfactant, and water-soluble solvent including water. The waste liquid tank 64 stores the drained ink and cleaning liquid. Further, the pump Pm is disposed between the switching valve 60a and the waste liquid tank 64, and is connected to the outlet port Po of the switching valve 60a.

The first liquid-draining channel P1 connects the pre-treatment liquid head 22b, as an example of the treatment liquid head 22, and the switching valve 60a such that the treatment liquid discharged to the treatment liquid cap 46 flows through the first liquid-draining channel P1, as depicted in FIG. 5A. Specifically, one end of the first liquid-draining channel P1 is connected to the treatment liquid cap 46, and the other end of the first liquid-draining channel P1 is connected to the first inlet port Pe1 of the switching valve 60a.

The second liquid-draining channel P2 connects the white ink head 21w, as an example of the ink head 21, and the switching valve 60a such that the white ink discharged to the ink cap 47 flows through the second liquid-draining channel P2, as depicted in FIG. 6A. Specifically, one end of the second liquid-draining channel P2 is connected to the ink cap 47, and the other end of the second liquid-draining channel P2 is connected to the second inlet port Pe2 of the switching valve 60a.

The first cleaning liquid-supplying channel P4 connects the cleaning liquid tank 63 to the switching valve 60a via the treatment liquid cap 46 such that the cleaning liquid in the cleaning liquid tank 63 flows through the first cleaning liquid-supplying channel P4, as depicted in FIG. 5B. Specifically, the first cleaning liquid-supplying channel P4 is constructed of the supply channel P3 and the above-described first liquid-draining channel P1. One end of the supply channel P3 is connected to the cleaning liquid tank 63, and the other end of the supply channel P3 is connected to the treatment liquid cap 46. The supply channel P3 includes the on-off valve Va2. The supply channel P3 is opened or closed in the opening-closing operation of the on-off valve Va2.

The second cleaning liquid-supplying channel P6 connects the cleaning liquid tank 63 to the switching valve 60a via the ink cap 47 such that the cleaning liquid in the cleaning liquid tank 63 flows through the second liquid-supplying channel P6, as depicted in FIG. 6B. Specifically, the second cleaning liquid-supplying channel P6 is constructed of a part of the supply channel P3, the supply channel P5, and the above-described second liquid-draining channel P2. One end of the supply channel P5 is connected to a part, of the supply channel P3, which is located between the on-off valve Va2 and the cleaning liquid tank 63 as described above, and the other end of the supply channel P5 is connected to the ink cap 47. The supply channel P5 includes the on-off valve Va3. The supply channel P5 is opened or closed in the opening-closing operation of the on-off valve Va3.

The suction channel P8 is constructed of an atmosphere-communicating channel P7, a part of the above-described supply channel P3, and the above-described first liquid-draining channel P1, as depicted in FIG. 5C. One end of the atmosphere-communicating channel P7 is communicated with the atmosphere, and the other end of the atmosphere-communicating channel P7 is connected to a part, of the above-described supply channel P3, which is upstream of the on-off valve Va2. In such a configuration, the suction channel P8 connects the atmosphere-communicating channel P7 to the switching valve 60a via the treatment liquid cap 46 so as to pass the air. The atmosphere-communicating channel P7 includes the on-off valve Va1. The atmosphere-communicating channel P7 is opened or closed in the opening-closing operation of the on-off valve Va1.

The suction channel P9 is constructed of the above-described atmospheric-communicating channel P7, the part of the above-described supply channel P3, the above-described supply channel P5, and the above-described second liquid-draining channel P2, as depicted in FIG. 6C. In such a configuration, the suction channel P9 connects the atmosphere-communicating channel P7 to the switching valve 60a via the ink cap 47 so as to pass the air.

The cleaning liquid bypass channel Pb connects the cleaning liquid tank 63 to the switching valve 60a, not via the treatment liquid cap 46 and ink cap 47, such that the cleaning liquid flows through the cleaning liquid bypass channel Pb, as depicted in FIG. 7A. Specifically, the cleaning liquid bypass channel Pb is constructed of a part of the supply channel P3, and a supply channel P10. One end of the supply channel P10 is connected to a part, of the supply channel P3, which is upstream of the on-off valve Va2, and the other end of the supply channel P10 is connected to the third inlet port Pe3 of the switching valve 60a. As described above, the other end of the atmosphere-communicating channel P7 is connected to the part, of supply channel P3, which is upstream of the on-off valve Va2, and thus the atmosphere-communicating channel P7 is connected to the cleaning liquid bypass channel Pb so as to supply the air to the switching valve 60a via the cleaning liquid bypass channel Pb, as depicted in FIG. 7B.

A process executed by the controller 50 in the configuration depicted in each of FIG. 5A to FIG. 7B will be described in order. First, a process related to the pre-treatment liquid head 22b will be described. As depicted in FIG. 5A, the controller 50 executes a first covering process of covering the treatment liquid nozzle surface 22s of the pre-treatment liquid head 22b with the treatment liquid cover 46 by using the lifting device 32. Then, the controller 50 executes a treatment liquid-purging process by activating the pump Pm so as to suck the pre-treatment liquid from the treatment liquid nozzle holes Hs of the pre-treatment liquid head 22b and to discharge the pre-treatment liquid to the treatment liquid cap 46. With this, the pre-treatment liquid is stored in the treatment liquid cap 46.

Next, the controller 50 causes the switching motor M5 to rotate the rotary member 61 of the switching valve 60a so that the slit 61s of the rotary member 61 is connected to the first inlet port Pe1. With this, the first liquid-draining channel P1 is connected to the outlet port Po, thereby connecting the first liquid-draining channel P1 to the pump Pm via the outlet port Po. In a state that the controller 50 causes the switching valve 60a of the channel switching mechanism 60 to connect the first liquid-draining channel P1 to the outlet port Po in such a manner, the controller 50 activates the pump Pm, and executes a first liquid-draining process of draining the pre-treatment liquid, which has been discharged to the treatment liquid cap 46, from the treatment liquid cap 46 via the first liquid-draining channel P1, as depicted in FIG. 5A. In this case, the pre-treatment liquid in the treatment liquid cap 46 is drained into the waste liquid tank 64 via the first liquid-draining channel P1.

Then, as depicted in FIG. 5B, the controller 50 causes the switching valve 60a of the channel switching mechanism 60 to connect the first cleaning liquid-supplying channel P4 to the outlet port Po. In this case, the controller 50 causes the rotary member 61 to rotate so that the slit 61s of the rotary member 61 is connected to the first inlet port Pe1 as described above, and the controller 50 closes the on-off valve Va1 and opens the on-off valve Va2. Further, the controller 50 activates the pump Pm, and executes a first cleaning process of supplying the cleaning liquid in the cleaning liquid tank 63 to the cleaning liquid cap 46. In this case, the cleaning liquid in the cleaning liquid tank 63 is supplied to the treatment liquid cap 46 via the supply channel P3. With this, the cleaning liquid supplied to the treatment liquid cap 46 comes into contact with the treatment liquid nozzle surface 22s of the pre-treatment liquid head 22b. Afterwards, the controller 50 activates the pump Pm to thereby drain the cleaning liquid in the treatment liquid cap 46 into the waste liquid tank 64 via the first liquid-draining channel P1.

Next, in a state that the first liquid-draining channel P1 is connected to the outlet port Po and the on-off valve Va2 is opened as described above, the controller 50 opens the on-off valve Va1, as depicted in FIG. 5C. With this, the suction channel P8 is connected to the outlet port Po. Then, the controller 50 activates the pump Pm to thereby supply the air to the suction channel P8, the treatment liquid cap 46, and the switching valve 60a. With this, the pre-treatment liquid and the cleaning liquid remaining in the suction channel P8, the treatment liquid cap 46, and the switching valve 60a can be drained into the waste liquid tank 64. Although an aspect in which the first cleaning process is executed after the treatment liquid-purging process and after the first liquid-draining process has been described in the foregoing, the present disclosure is not limited to this aspect. The first cleaning process may be executed between the treatment liquid-purging process and the first liquid-draining process. With this, the cleaning liquid in the first cleaning process (i.e., the cleaning liquid in the treatment liquid cap 46) can be drained into the waste liquid tank 64 via the first liquid-draining channel P1, together with the pre-treatment liquid in the first liquid-draining process (i.e., the pre-treatment liquid in treatment liquid cap 46).

Here, the controller 50 executes a determining process of determining whether to execute the above-described first cleaning process, based on the number of times each of the above-described treatment liquid-purging process and the above-described first liquid-draining process has been executed. In this case, the controller 50 compares the number of times each of the treatment liquid-purging process and the first liquid-draining process has been executed with a threshold value; in a case where the number of times each of the treatment liquid-purging process and the first liquid-draining process has been executed is the threshold value or more, the controller 50 determines that the first cleaning process may be executed.

Next, a process related to the white ink head 21w will be described. As depicted in FIG. 6A, the controller 50 executes a second covering process of covering the ink nozzle surface 21s of the white ink head 21w with the ink cap 47 by using the lifting device 33. Then, the controller 50 activates the pump Pm, and executes an ink purging process of sucking the white ink from the white ink nozzle holes Hk of the white ink head 21w and of discharging the white ink to the white ink cap 47. With this, the white ink is stored in the ink cap 47.

Next, the controller 50 causes the switching motor M5 to rotate the rotary member 61 of the switching valve 60a so that the slit 61s of the rotary member 61 is connected to the second inlet port Pe2. With this, the second liquid-draining channel P2 is connected to the outlet port Po, thereby connecting the second liquid-draining channel P2 to the pump Pm via the outlet port Po. In a state that the controller 50 causes the switching valve 60a of the channel switching mechanism 60 to connect the second liquid-draining channel P2 to the outlet port Po in such a manner, the controller 50 activates the pump Pm, and execute a second liquid-draining process of draining the ink, which has been discharged to the ink cap 47, from the ink cap 47 via the second liquid-draining channel P2, as depicted in FIG. 6A. In this case, the ink in the ink cap 47 is drained into the waste liquid tank 64 via the second liquid-draining channel P2.

Then, as depicted in FIG. 6B, the controller 50 causes the switching valve 60a of the channel switching mechanism 60 to connect the second cleaning liquid-supplying channel P6 to the outlet port Po. In this case, the controller 50 causes the rotary member 61 to rotate so that the slit 61s of the rotary member 61 is connected to the second inlet port Pe2 as described above, and the controller 50 closes the on-off valve Va1 and opens the on-off valve Va3. Further, the controller 50 activates the pump Pm, and executes a second cleaning process of supplying the cleaning liquid in the cleaning liquid tank 63 to the ink cap 47. In this case, the cleaning liquid in the cleaning liquid tank 63 is supplied to the ink cap 47 via the supply channels P3 and P5, each as a part of the supply channel P6. With this, the cleaning liquid supplied to the ink cap 47 comes into contact with the ink nozzle surface 21s of the white ink head 21w. Afterwards, the controller 50 activates the pump Pm to thereby drain the cleaning liquid in the ink cap 47 into the waste liquid tank 64 via the second liquid-draining channel P2.

Next, in a state that the second liquid-draining channel P2 is connected to the outlet port Po and the on-off valve Va3 is opened as described above, the controller 50 opens the on-off valve Va1, as depicted in FIG. 6C. With this, the suction channel P9 is connected to the outlet port Po. Then, the controller 50 activates the pump Pm to thereby supply the air to the suction channel P9, the ink cap 47, and the switching valve 60a. With this, the ink and the cleaning liquid remaining in the suction channel P9, the ink cap 47, and the switching valve 60a can be drained into the waste liquid tank 64.

Here, the controller 50 executes a determining process of determining whether to execute the above-described second cleaning process, based on the number of times each of the above-described ink purging process and the above-described second liquid-draining process has been executed. In this case, the controller 50 compares the number of times each of the ink purging process and the second liquid-draining process has been executed with a threshold value; in a case where the number of times each of the ink purging process and the second liquid-draining process has been executed is the threshold value or more, the controller 50 determines that the second cleaning process may be executed.

Next, a process related to the cleaning liquid bypass channel Pb will be described. As depicted in FIG. 7A, the controller 50 causes the switching valve 60a of the channel switching mechanism 60 to connect the supply channel P10 of the cleaning liquid bypass channel Pb to the outlet port Po. In this case, the controller 50 causes the rotary member 61 to rotate so that the slit 61s of the rotary member 61 is connected to the third inlet port Pe3, and the controller 50 closes the on-off valve Va1. Further, the controller 50 activates the pump Pm to thereby supply the cleaning liquid in the cleaning liquid tank 63 to the switching valve 60a, not via the treatment liquid cap 46 and the ink cap 47. The cleaning liquid stored in the switching valve 60a is drained into the waste liquid tank 64.

Next, in a state that the supply channel P10 of the cleaning liquid bypass channel Pb is connected to the outlet port Po as described above, the controller 50 opens the on-off valve Va1, as depicted in FIG. 7B. With this, the atmosphere-communicating channel P7 is connected to the outlet port Po, via the cleaning liquid bypass channel Pb. Then, the controller 50 activates the pump Pm to thereby supply the air to the cleaning liquid bypass channel Pb and the switching valve 60a. With this, the cleaning liquid remaining in the cleaning liquid bypass channel Pb and the switching valve 60a can be drained into the waste liquid tank 64.

Here, although the process related to the pre-treatment liquid head 22b has been described above, a process related to the post-treatment liquid head 22a can be executed similarly to the pre-treatment liquid head 22b. The process related to the post-treatment liquid head 22a will be described below.

The controller 50 executes a third covering process of covering the treatment liquid nozzle surface 22s of the post-treatment liquid head 22a with the treatment liquid cover 46 by using the lifting device 32. Then, the controller 50 activates the pump Pm so as to suck the post-treatment liquid from the treatment liquid nozzle holes Hs of the post-treatment liquid head 22a and to discharge the post-treatment liquid to the treatment liquid cap 46. With this, the post-treatment liquid is stored in the treatment liquid cap 46.

Next, the controller 50 causes the switching valve 60a of the channel switching mechanism 60 to connect the first liquid-draining channel P1 to the outlet port Po in a similar manner to the foregoing, and activates the pump Pm so as to execute a third liquid-draining process of draining the post-treatment liquid, which has been discharged to the treatment liquid cap 46, from the treatment liquid cap 46 via the first liquid-draining channel P1. In this case, the post-treatment liquid in the treatment liquid cap 46 is drained into the waste liquid tank 64 via the first liquid-draining channel P1.

Then, the controller 50 causes the switching valve 60a of the channel switching mechanism 60 to connect the first cleaning liquid-supplying channel P4 to the outlet port Po. In this case, the controller 50 causes the rotary member 61 to rotate so that the slit 61s of the rotary member 61 is connected to the first inlet port Pe1 as described above to thereby connect the first cleaning liquid-supplying channel P4 to the outlet port Po via the first inlet port Pe1, and the controller 50 closes the on-off valve Va1 and opens the on-off valve Va2. Further, the controller 50 activates the pump Pm, and executes a third cleaning process of supplying the cleaning liquid in the cleaning liquid tank 63 to the cleaning liquid cap 46. In this case, the cleaning liquid in the cleaning liquid tank 63 is supplied to the treatment liquid cap 46 via the supply channel P3. With this, the cleaning liquid supplied to the treatment liquid cap 46 comes into contact with the treatment liquid nozzle surface 22s of the post-treatment liquid head 22a. Afterwards, the controller 50 activates the pump Pm to thereby drain the cleaning liquid in the treatment liquid cap 46 into the waste liquid tank 64 via the first liquid-draining channel P1.

Next, in a state that the first liquid-draining channel P1 is connected to the outlet port Po and the on-off valve Va2 is opened as described above, the controller 50 opens the on-off valve Va1. With this, the suction channel P8 is connected to the outlet port Po. Then, the controller 50 activates the pump Pm to thereby supply the air to the suction channel P8, the treatment liquid cap 46, and the switching valve 60a. With this, the post-treatment liquid and the cleaning liquid remaining in the suction channel P8, the treatment liquid cap 46, and the switching valve 60a are drained into the waste liquid tank 64.

The controller 50 executes a determining process of determining whether to execute the above-described third cleaning process, based on the number of times each of the above-described treatment liquid-purging process and the above-described third liquid-draining process has been executed, with respect also to the post-treatment liquid head 22a, similarly to the pre-treatment liquid head 22b. In this case, the controller 50 compares the number of times each of the treatment liquid-purging process and the third liquid-draining process has been executed with a threshold value; in a case where the number of times each of the treatment liquid-purging process and the third liquid-draining process has been execute is the threshold value or more, the controller 50 determines that the third cleaning process may be executed.

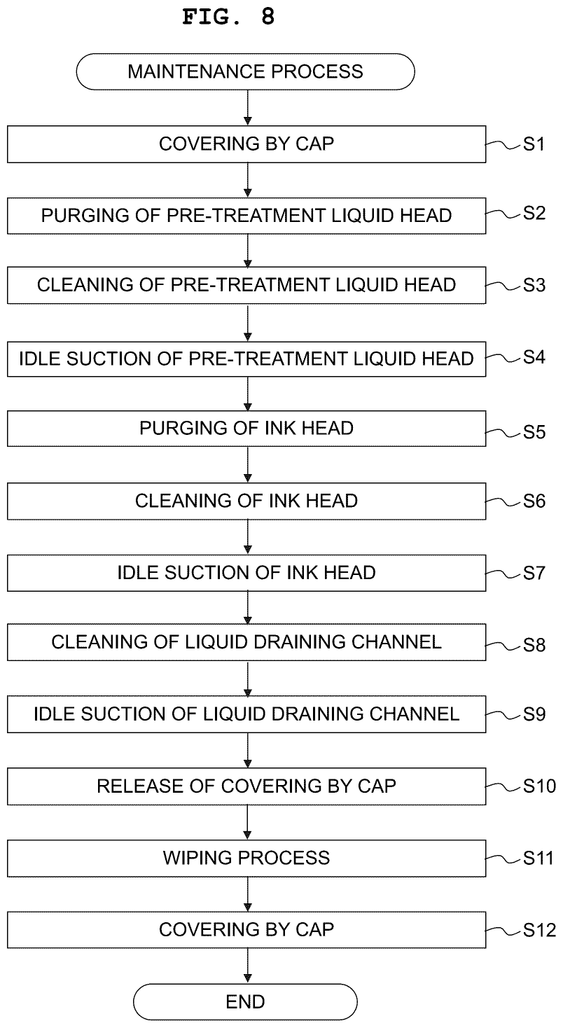

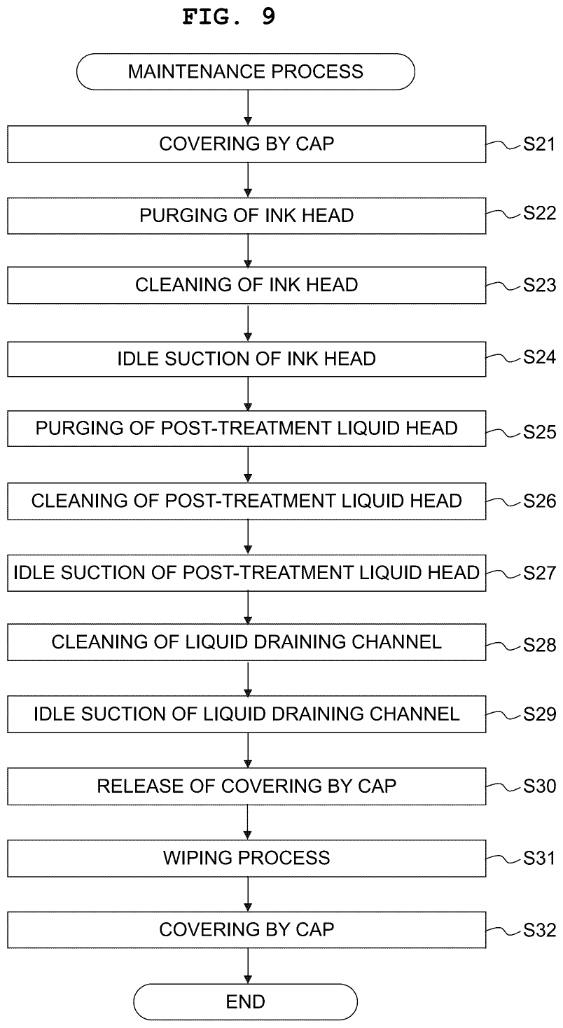

FIG. 8 is a flowchart depicting the flow of a maintenance process for the pre-treatment liquid head 22b and the white ink head 21w. FIG. 9 is a flowchart depicting the flow of a maintenance process for the color ink head 21c and the post-treatment liquid head 22a. Note that in the example depicted in FIG. 8 and the example depicted in FIG. 9, an aspect wherein the treatment liquid cap 46 and the ink cap 47 are lifted and lowered by a common lifting device will be described.

As indicated in FIG. 8, the controller 50 first executes the first covering process of causing the treatment liquid cover 46 to cover the treatment liquid nozzle surface 22s of the pre-treatment liquid head 22b, and executes a second covering process of causing the ink cap 47 to cover the ink nozzle surface 21s of the white ink head 21w, at the same timing as the first covering process (step S1). Next, the controller 50 executes the treatment liquid-purging step of sucking the pre-treatment liquid from the treatment liquid nozzle holes Hs of the pre-treatment liquid head 22b and discharging the pre-treatment liquid to the treatment liquid cap 46 (step S2). After the treatment liquid-purging process, the pre-treatment liquid in the treatment liquid cap 46 is drained into the waste liquid tank 64.

Then, the controller 50 executes the first cleaning process of supplying the cleaning liquid in the cleaning liquid tank 63 to the treatment liquid cap 46 (step S3). The treatment liquid nozzle surface 22s of the pre-treatment liquid head 22b is cleaned in the first cleaning process. Then, the controller 50 supplies the air to the suction channel P8, the treatment liquid cap 46, and the switching valve 60a (step S4). With this, the pre-treatment liquid and the cleaning liquid remaining in the switching valve 60a, etc., are drained into the waste liquid tank 64.

Next, the controller 50 executes the ink purging process of sucking the white ink from the ink nozzle holes Hk of the white ink head 21w and of discharging the white ink to the ink cap 47 (step S5). After the ink purging process, the white ink in the ink cap 47 is drained into the waste liquid tank 64. Here, the controller 50 may execute a preliminary cleaning process before the above-described ink purging process. In this case, the controller 50 activates the pump Pm so as to supply the cleaning liquid in the cleaning liquid tank 63 to ink cap 47 via the second cleaning liquid-supplying channel P6, and then to drain the cleaning liquid, which has been supplied to the ink cap 47 via the second cleaning liquid-supplying channel P6, from the ink cap 47 via the second liquid-draining channel P2. With this, the ink cap 47, the second liquid-draining channel P2, and the switching valve 60a through each of which the white or color ink flows during the ink purging process, can be wetted with the cleaning liquid in advance. In such a preliminary cleaning process, the suction force of the pump Pm may be smaller than the suction force of the pump Pm in the ink purging process. In this case, the controller 50 reduces the rotational speed of the pump motor M6 of the pump Pm in the preliminary cleaning process to be lower than the rotational speed of the pump motor M6 of the pump Pm in the ink purging process. With this, liquid droplets of the cleaning liquid can remain in the second liquid-draining channel P2 and the switching valve 60a, in advance.

Then, the controller 50 executes the second cleaning process of supplying the cleaning liquid in the cleaning liquid tank 63 to the ink cap 47 (step S6). The ink nozzle surface 21s of the white ink head 21w is cleaned in the second cleaning process. Then, the controller 50 supplies the air to the suction channel P9, the ink cap 47, and the switching valve 60a (step S7). With this, the white ink and the cleaning liquid remaining in the switching valve 60a, etc., are drained into the waste liquid tank 64.

Next, the controller 50 supplies the cleaning liquid in the cleaning liquid tank 63 to the switching valve 60a via the cleaning liquid bypass channel Pb, not via the treatment liquid cap 46 and the ink cap 47 (step S8). Then, the controller 50 supplies the air to the cleaning liquid bypass channel Pb and the switching valve 60a (step S9). The controller 50 releases the covering of the treatment liquid nozzle surface 22s with the treatment liquid cap 46 and the covering of the ink nozzle surface 21s with the ink cap 47 (step S10). Next, the controller 50 causes the carriage 41 to move the pre-treatment liquid head 22b and the white ink head 21w to a predetermined position and executes a wiping process on the treatment liquid nozzle surface 22s and the ink nozzle surface 21s with a non-illustrated wiper member (step S11). Then, the controller 50 causes the carriage 41 to move the pre-treatment liquid head 22b and the white ink head 21w, causes the treatment liquid cap 46 to cover the treatment liquid nozzle surface 22s, and causes the ink cap 47 to cover the ink nozzle surface 21s (step S12).

As depicted in FIG. 9, the controller 50 first executes the third covering process of causing the treatment liquid cap 46 to cover the treatment liquid nozzle surface 22s of the post-treatment liquid head 22a and executes the second covering process of causing the ink cap 47 to cover the ink nozzle surface 21s of the color ink head 21c, at the same timing as the third covering process (step S21).

Next, the controller 50 executes the ink purging step of sucking the color ink from the ink nozzle holes Hk of the color ink head 21c and discharging the color ink to the ink cap 47 (step S22). After the ink purging process, the color ink in the ink cap 47 is drained into the waste liquid tank 64. Then, the controller 50 executes the second cleaning process of supplying the cleaning liquid in the cleaning liquid tank 63 to the ink cap 47 (step S23). The ink nozzle surface 21s of the color ink head 21c is cleaned in the second cleaning process. Then, the controller 50 supplies the air to the suction channel P9, the ink cap 47, and the switching valve 60a (step S24). With this, the color ink and the cleaning liquid remaining in the switching valve 60a, etc., are drained into the waste liquid tank 64.

Next, the controller 50 executes the treatment liquid purging process of sucking the treatment liquid from the treatment liquid nozzle holes Hs of the post-treatment liquid head 22a and of discharging the post-treatment liquid to the treatment liquid cap 46 (step S25). After the treatment liquid purging process, the post-treatment liquid ink in the treatment liquid cap 46 is drained into the waste liquid tank 64.

Then, the controller 50 executes the third cleaning process of supplying the cleaning liquid in the cleaning liquid tank 63 to the treatment liquid cap 46 (step S26). The treatment liquid nozzle surface 22s of the post-treatment liquid head 22a is cleaned in the third cleaning process. Then, the controller 50 supplies the air to the suction channel P8, the treatment liquid cap 46, and the switching valve 60a (step S27). With this, the post-treatment liquid and the cleaning liquid remaining in the switching valve 60a, etc., are drained into the waste liquid tank 64.

Next, the controller 50 supplies the cleaning liquid in the cleaning liquid tank 63 to the switching valve 60a via the cleaning liquid bypass channel Pb, not via the treatment liquid cap 46 and the ink cap 47 (step S28). Then, the controller 50 supplies the air to the cleaning liquid bypass channel Pb and the switching valve 60a (step S29). The controller 50 releases the covering of the treatment liquid nozzle surface 22s with the treatment liquid cap 46 and the covering of the ink nozzle surface 21s with the ink cap 47 (step S30). Next, the controller 50 causes the carriage 41 to move the post-treatment liquid head 22a and the color ink head 21c to a predetermined position and executes a wiping process on the treatment liquid nozzle surface 22s and the ink nozzle surface 21s with the non-illustrated wiper member (step S31). Then, the controller 50 causes the carriage 41 to move the post-treatment liquid head 22b and the color ink head 21c, causes the treatment liquid cap 46 to cover the treatment liquid nozzle surface 22s, and causes the ink cap 47 to cover the ink nozzle surface 21s (step S32).

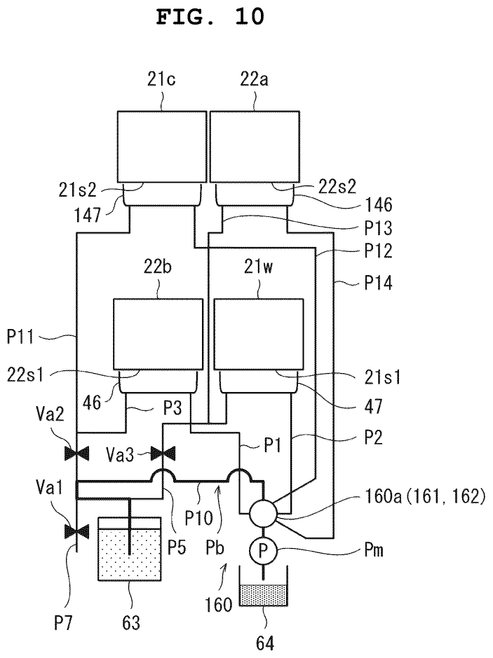

In the above-described configuration, although the carriage 41 supports the pre-treatment liquid head 22b and the white ink head 21w, the carriage 41 may also support the color ink head 21c and post-treatment liquid head 22a together with the pre-treatment liquid head 22b and the white ink head 21w, as will be described below. FIG. 10 is a view depicting an aspect wherein the carriage 41 supports the pre-treatment liquid head 22b, the white ink head 21w, the color ink head 21c, and the post-treatment liquid head 22a. In the configuration of FIG. 10, only the points different from the configuration depicted in FIG. 7A and FIG. 7B will be described.

As depicted in FIG. 10, a treatment liquid cap 146 and an ink cap 147 are disposed, separately from a treatment liquid cap 46 covering a treatment liquid nozzle surface 22s1 of the pre-treatment liquid head 22b and an ink cap 47 covering an ink nozzle surface 21s1 of the white ink head 21w. Further, a supply channel P11, a liquid-draining channel P12, a supply channel P13, and a liquid-draining channel P14 are included, and a channel switching mechanism 160 including a switching valve 160a having a rotary member 161 and a stationary member 162 is disposed, rather than the channel switching mechanism 60 including the switching valve 60a depicted in FIG. 7A and FIG. 7B. The operation of the switching valve 160a is basically the same as the operation of the switching valve 60a. The switching valve 160a has an outlet port and five inlet ports which are a first inlet to a fifth inlet port. The rotary member 161 rotates at a predetermined rotation angle and a slit of the rotary member 161 is connected to one of the first inlet port to the fifth inlet port. With this, one of the above-described inlet ports is connected to the outlet port.

The treatment liquid cap 146 covers the treatment liquid nozzle surface 22s2 of the post-treatment liquid head 22a, and the ink cap 147 covers the ink nozzle surface 21s2 of the color ink head 21c. Further, one end of the supply channel P11 is connected to a part, of supply channel P3, located downstream of the on-off valve Va2, and the other end of the supply channel P11 is connected to the ink cap 147. One end of the liquid-draining channel P12 is connected to the ink cap 147, and the other end of the liquid-draining channel P12 is connected to the fourth inlet port of the switching valve 160a. Furthermore, one end of the supply channel P13 is connected to a part, of supply channel P5, located downstream of the on-off valve Va3, and the other end of the supply channel P13 is connected to the treatment liquid cap 146. One end of the liquid-draining channel P14 is connected to the treatment liquid cap 146, and the other end of the liquid-draining channel P14 is connected to the fifth inlet port of the switching valve 160a.

Also in the configuration depicted in FIG. 10, similarly to the configuration depicted in FIG. 7A, the controller 50 closes the on-off valve Va1 and activates the pump Pm to supply the cleaning liquid in the cleaning liquid tank 63 to the switching valve 160a via the cleaning liquid bypass channel Pb, not via the treatment liquid caps 46 and 146 and the ink caps 47 and 147. Thus, the switching valve 160a, etc., may be cleaned with the cleaning liquid.

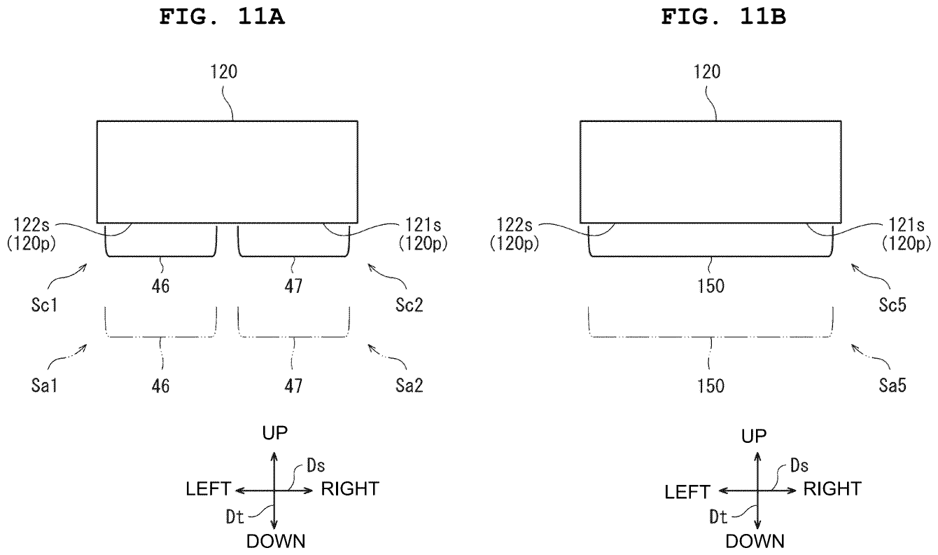

In the foregoing description, although the pre-treatment liquid head 22b and the white ink head 21w are disposed separately and independently, a treatment liquid nozzle surface from which the treatment liquid is ejected and the ink nozzle surface from which the ink is ejected may be disposed in one ejecting head, as described below. FIG. 11A is a view depicting an ejecting head 120, a treatment liquid cap 46, and an ink cap 47 corresponding to the ejecting head 120. FIG. 11B is a view depicting the ejecting head 120, and a cap 150 corresponding to the ejecting head 120. The processes such as the cleaning process, etc., executed by the controller 50 in the configuration of FIG. 11A and FIG. 11B are basically the same as the above-described cleaning process, etc.

As depicted in FIG. 11A, the ejecting head 120 has a nozzle plate 120p. Treatment liquid nozzle holes Hs from which treatment liquid including one of the pre-treatment liquid, the post-treatment liquid, or both the pre-treatment liquid and the post-treatment liquid is ejected, and ink nozzle holes Hk from which ink including one of the white ink, the color ink, or both the white ink and the color ink is ejected extend through the nozzle plate 120p.

A treatment liquid nozzle surface 122s, which is a surface of the nozzle plate 120p and through which the treatment liquid nozzle holes Hs extend, may be in a capped state Sc1 in which the treatment liquid nozzle surface 122s is covered by the treatment liquid cap 46 or in an uncapped state Sa1 in which the treatment liquid nozzle surface 122s is not covered by the treatment liquid cap 46. Further, an ink nozzle surface 121s which is the surface, of the nozzle plate 120p, and through which the ink nozzle holes Hk extend may be in a capped state Sc2 in which the ink nozzle surface 121s is covered by the ink cap 47, or an uncapped state Sa2 in which the ink nozzle surface 121s is not covered by the ink cap 47.

As depicted in FIG. 11B, the ejecting head 120 has a nozzle plate 120p. Treatment liquid nozzle holes Hs from which treatment liquid including one of the pre-treatment liquid, the post-treatment liquid, or both the pre-treatment liquid and the post-treatment liquid is ejected, and ink nozzle holes Hk from which ink including one of the white ink, the color ink, or both the white ink and the color ink is ejected extend through the nozzle plate 120p.

A treatment liquid nozzle surface 122s, which is a surface of the nozzle plate 120p and through which the treatment liquid nozzle holes Hs extend, and an ink nozzle surface 121s which is the surface, of the nozzle plate 120p and through which the ink nozzle holes Hk extend may be in a capped state Sc5 in which the treatment liquid nozzle surface 122s and the ink nozzle surface 121s are covered by the treatment liquid cap 150 at the same time, or in an uncapped state Sa5 in which the treatment liquid nozzle surface 122s and the ink nozzle surface 121s are not covered by the treatment liquid cap 150 at the same time.

As described above, according to the liquid ejecting apparatus 100 of the present embodiment, the cleaning liquid in the cleaning liquid tank 63 is supplied to the switching valve 60a via the cleaning liquid bypass channel Pb, not via the treatment liquid cap 46 and the ink cap 47. The cleaning liquid directly supplied from the cleaning liquid tank 63 to the switching valve 60a in such a manner causes the white ink, the color ink, the pre-treatment liquid and the post-treatment liquid which are present in the switching valve 60a and the pump Pm connected to the switching valve 60a via the tube to be easily diluted. With this, the solidification of the ink due to the contact between the ink and the treatment liquid in the channel including the switching valve 60a, etc., can be reduced.

Further, in the present embodiment, the atmosphere-communicating channel P7 is connected to the cleaning liquid bypass channel Pb, and the air is supplied to the switching valve Pb via the cleaning liquid bypass channel Pb. With this, the cleaning liquid remaining in the cleaning liquid bypass channel Pb and the switching valve 60a can be drained into the waste liquid tank 64.

Furthermore, in the present embodiment, the white ink head 21w ejects the white ink to the part, of the recording medium W, to which the pre-treatment liquid head 22b has ejected the pre-treatment liquid. Since the white ink is steadily ejected to the part which has been pre-treated with the pre-treatment liquid, the fixability of the white ink can be improved.

Moreover, in the present embodiment, the post-treatment liquid head 22a ejects the post-treatment liquid to the part, of the recording medium W, to which the color ink head 21c has ejected the color ink. Since the post-treatment liquid is steadily ejected to the part to which the color ink has been ejected, the post-treatment on the color ink can be suitably executed.

Further, in the present embodiment, the controller 50 executes the determining process of determining whether the above-described first cleaning process is to be executed, based on the number of times the above-described treatment liquid-purging process has been executed and the number of times the above-described first liquid-draining process has been executed. With this, the timing at which the first cleaning process is to be executed can be set at a suitable timing.

Furthermore, in the present embodiment, the controller 50 executes the determining process of determining whether the above-described second cleaning process is to be executed, based on the number of times the above-described ink purging process has been executed and the number of times the above-described second liquid-draining process has been executed. With this, the timing at which the second cleaning process is to be executed can be set at a suitable timing.

Moreover, in the present embodiment, the controller 50 executes, also with respect to the post-treatment liquid head 22a, the determining process of determining whether the third cleaning process is to be executed, based on the number of times the above-described treatment liquid-purging process has been executed and the number of times the above-described third liquid-draining process has been executed, similarly to the pre-treatment liquid head 22b. With this, the timing at which the third cleaning process is to be executed can be set at a suitable time.

Further, in the present embodiment, the carriage 41 may support the color ink head 21c and the post-treatment liquid head 22a, together with the white ink head 21w and the pre-treatment liquid head 22b. In this case, various processes, such as the cleaning process, etc., may be executed with respect to the above-described four heads, by using the channel switching mechanism 160 which is common to the above-described four heads.

Furthermore, in the present embodiment, the ink contains the solid content, and the solid content includes the resin fine particles and the solid content of the colorant. Furthermore, the resin fine particles are contained in the ink in the range of 0.1 wt % to 30 wt %, and the solid content of the colorant is contained in the ink in the range of 0.1 wt % to 20 wt %. Moreover, the cleaning liquid is a liquid which does not contain a solid content and contains other materials different from the solid content. As described above, since the ink is such a liquid that requires the cleaning liquid so that the ink is removed, the ink adheres strongly to the switching valve 60a, etc., and inhibits the operation of the switching valve 60a. In the present embodiment, since the cleaning liquid does not contain the solid content, the solid content does not remain in the switching valve 60a after the cleaning liquid is caused to flow through the switching valve 60a, compared to a case where the cleaning liquid contains a solid content, and thus the cleaning liquid hardly inhibits the operation of the switching valve 60a. Further, since the cleaning liquid is capable of reducing the viscosity of the ink, such an occasion that the operation of the switching valve 60a is inhibited can be reduced.

Furthermore, in the present embodiment, the controller 50 may execute the preliminary cleaning process before the ink purging process. With this, the ink cap 47, the second liquid-draining channel P2, and the switching valve 60a through each of which the white or color ink flows during the ink purging process, can be wetted with the cleaning liquid in advance. Therefore, even in a case where a high viscous ink is used, the viscosity of the ink can be reduced owing to the contact between the ink and the cleaning liquid in the preliminarily cleaning process, thus reducing or preventing such an occasion that the ink solidifies, for example, in the switching valve 60a.

Furthermore, in the present embodiment, the suction force of the pump Pm in the preliminary cleaning process may be smaller than the suction force of the pump Pm in the ink purging process. In this case, the power consumption of the pump motor M6 of the pump Pm in the preliminary cleaning process is reduced.

Moreover, in the present disclosure, an ejecting head 120 having the nozzle plate 120p through which the treatment liquid nozzle holes Hs and the ink nozzle holes Hk extend may be applied. In this case, the treatment liquid head and the ink head do not need to be separated, thereby simplifying the structure of the liquid ejecting apparatus 100.

Further, in the present embodiment, one cap 150 may be applied to an ejecting head 120 including the treatment liquid nozzle surfaces 122s and the ink nozzle surfaces 121s. In this case, the treatment liquid cap 46 and the ink cap 47 do not need to be separated, thereby simplifying the structure of the liquid ejecting apparatus 100.

Although the other embodiments are described above, the present disclosure may adopt the following modifications within the range not departing from the gist of the present disclosure.

In the above-described embodiment, an on-off valve may be additionally disposed in a part, of the supply channel P3, located upstream of a joining part at which the atmosphere-communicating channel P7 joins the supply channel P3.

Further, in the above-described embodiment, although the ink head 21 is exemplified as the ink-jet head which ejects the white ink or the color ink, the present disclosure is not limited to this. For example, an ink head which ejects clear ink or special color ink may also be applied.

Moreover, in the above-described embodiment, the ink head 21 may eject only the white ink, and the treatment liquid head 22 may eject only pre-treatment liquid. In this case, the ink head 21 does not even include a channel for the color ink, and the treatment liquid head 22 does not even include a channel for the post-treatment liquid. In other words, the liquid ejecting apparatus 100 may be a printing apparatus dedicated to print a white base on a printing medium by causing the treatment liquid head 22 to eject the pre-treatment liquid to the printing medium, and then causing the ink-jet head 21 to eject the white ink to the printing medium.

Further, in the above-described embodiment, although the ink-jet head 21 is of the serial head type, the ink-jet head 21 may be of a line head type.

What is claimed is:

1. A liquid ejecting apparatus comprising:
a treatment liquid head having a treatment liquid nozzle plate, the treatment liquid nozzle plate having treatment liquid nozzle holes, treatment liquid being ejected from the treatment liquid nozzle holes, the treatment liquid including one of pre-treatment liquid, post-treatment liquid, or both the pre-treatment liquid and the post-treatment liquid;
an ink head having an ink nozzle plate, the ink nozzle plate having ink nozzle holes, ink being ejected from the ink nozzle holes, the ink including one of white ink, color ink, or both the white ink and the color ink;
a treatment liquid cap, a treatment liquid nozzle surface as a surface of the treatment liquid nozzle plate being covered by the treatment liquid cap;
an ink cap, an ink nozzle surface as a surface of the ink nozzle plate being covered by the ink cap;
a cleaning liquid tank;
a plurality of channels; and
a channel switching mechanism including a switching valve having an outlet port and a plurality of inlet ports, a channel to be communicated with the outlet port being switched by the channel switching mechanism among the plurality of channels,
wherein the plurality of channels includes:
a first liquid-draining channel connecting the treatment liquid head and the switching valve, the treatment liquid discharged to the treatment liquid cap flowing through the first liquid-draining channel;
a second liquid-draining channel connecting the ink head and the switching valve, the ink discharged to the ink cap flowing through the second liquid-draining channel;
a first cleaning liquid-supplying channel connecting the cleaning liquid tank to the switching valve via the treatment liquid cap;
a second cleaning liquid-supplying channel connecting the cleaning liquid tank to the switching valve via the ink cap; and
a cleaning liquid bypass channel connecting the cleaning liquid tank to the switching valve not via the treatment liquid cap and the ink cap.

2. The liquid ejecting apparatus according to claim 1, further comprising:
a pump connected to the outlet port of the switching valve; and
an atmosphere-communicating channel connected to the cleaning liquid bypass channel, the switching valve being supplied with air via the cleaning liquid bypass channel.

3. The liquid ejecting apparatus according to claim 1, wherein
the treatment liquid head is a pre-treatment liquid head configured to eject the pre-treatment liquid as the treatment liquid,
the ink head is a white ink head configured to eject the white ink as the ink, and
the treatment liquid head ejects the pre-treatment liquid to a part of a recording medium, and then, the ink head ejects the white ink to the part of the recording medium.

4. The liquid ejecting apparatus according to claim 1, wherein,
the ink head is a color ink head configured to eject the color ink as the ink,
the treatment liquid head is a post-treatment liquid head configured to eject the post-treatment liquid as the treatment liquid, and
the color ink head ejects the color ink to a part of a recording medium, and then, the treatment liquid head ejects the post-treatment liquid to the part of a recording medium.

5. The liquid ejecting apparatus according to claim 1, further comprising:
a first switching mechanism, a first capped state and a first uncapped state being switched by the first switching mechanism, the treatment liquid nozzle surface being covered by the treatment liquid cap in the first capped state, the treatment liquid nozzle surface not being covered by the treatment liquid cap in the first uncapped state;
a pump connected to the outlet port of the switching valve; and
a controller,
wherein the controller is configured to execute:
a first covering process of causing the first switching mechanism to cover the treatment liquid nozzle surface with the treatment liquid cap;
a treatment liquid-purging process of activating the pump to discharge the treatment liquid from the treatment liquid nozzle holes to the treatment liquid cap;
a first liquid-draining process of causing the channel switching mechanism to connect the first liquid-draining channel to the outlet port and of activating the pump to drain the pre-treatment liquid, discharged to the treatment liquid cap, from the treatment liquid cap via the first liquid-draining channel;
a first cleaning process of causing the channel switching mechanism to connect the first cleaning liquid-supplying channel to the outlet port and of activating the pump to supply cleaning liquid in the cleaning liquid tank to the treatment liquid cap; and
a determining process of determining whether to execute the first cleaning process, based on a number of times each of the treatment liquid-purging process and the first liquid-draining process has been executed.

6. The liquid ejecting apparatus according to claim 1, further comprising:
a second switching mechanism, a second capped state and a second uncapped state being switched by the second switching mechanism, the ink nozzle surface being covered by the ink cap in the second capped state, and the ink nozzle surface not being covered by the ink cap in the second uncapped state;
a pump connected to the outlet port of the switching valve; and
a controller,
wherein the controller is configured to execute:
a second covering process of causing the second switching mechanism to cover the ink nozzle surface with the ink cap;
an ink purging process of activating the pump to suck the ink from the ink nozzle holes and discharge the ink to the ink cap;
a second liquid-draining process of causing the channel switching mechanism to connect the second liquid-draining channel to the outlet port and of activating the pump to drain the ink, discharged to the ink cap, from the ink cap via the second liquid-draining channel;
a second cleaning process of causing the channel switching mechanism to connect the second cleaning liquid-supplying channel to the outlet port and of activating the pump to supply cleaning liquid in the cleaning liquid tank to the ink cap; and
a determining process of determining whether to execute the second cleaning process, based on a number of times each of the ink purging process and the second liquid-draining process has been executed.

7. The liquid ejecting apparatus according to claim 1, further comprising:
a first switching mechanism, a third capped state and a third uncapped state being switched by the first switching mechanism, the treatment liquid nozzle surface being covered by the treatment liquid cap in the third capped state, and the treatment liquid nozzle surface not being covered by the treatment liquid cap in the third uncapped state;
a pump connected to the outlet port of the switching valve; and
a controller,
wherein the controller is configured to execute:
a third covering process of causing the first switching mechanism to cover the treatment liquid nozzle surface with the treatment liquid cap;
a treatment liquid-purging process of activating the pump to suck the post-treatment liquid from the treatment liquid nozzle holes and to discharge the post-treatment liquid to the treatment liquid cap;
a third liquid-draining process of causing the channel switching mechanism to connect the first liquid-draining channel to the outlet port and of activating the pump to drain the post-treatment liquid, discharged to the treatment liquid cap, from the treatment liquid cap via the first liquid-draining channel;
a third cleaning process of causing the channel switching mechanism to connect the first cleaning liquid-supplying channel to the outlet port and of activating the pump to supply cleaning liquid in the cleaning liquid tank to the treatment liquid cap; and
a determining process of determining whether to execute the third cleaning process, based on a number of times each of the treatment liquid-purging process and the third liquid-draining process has been executed.

8. The liquid ejecting apparatus according to claim 1, wherein
the treatment liquid head includes a pre-treatment liquid head and a post-treatment liquid head, the pre-treatment liquid being ejected by the pre-treatment liquid head, the post-treatment liquid being ejected by the post-treatment liquid head, and
the ink head includes a white ink head and a color ink head, the white ink being ejected by the white ink head, the color ink being ejected by the color ink head.

9. The liquid ejecting apparatus according to claim 6, wherein
the color ink contains a solid content,
the solid content includes resin fine particles and a solid content of a colorant,
the color ink contains the resin fine particles in a range of 0.1 wt % to 30 wt %,
the color ink contains the solid content of the colorant in a range of 0.1 wt % to 20 wt %, and
the cleaning liquid does not contain the solid content.

10. The liquid ejecting apparatus according to claim 9, wherein the controller is configured to execute a preliminary cleaning process of activating the pump to supply the cleaning liquid in the cleaning liquid tank to the ink cap via the second cleaning liquid-supplying channel, and then of draining the cleaning liquid, supplied to the ink cap via the second cleaning liquid-supplying channel, from the ink cap via the second liquid-draining channel, as a process to be executed before the ink purging process.

11. The liquid ejecting apparatus according to claim 10, wherein the pump is a suction type pump, and
a suction force of the pump in the preliminary cleaning process is smaller than a suction force of the pump in the ink purging process.

12. The liquid ejecting apparatus according to claim 1, further comprising:
a first switching mechanism, a first capped state and a first uncapped state being switched by the first switching mechanism, the treatment liquid nozzle surface being covered by the treatment liquid cap in the first capped state, and the treatment liquid nozzle surface not being covered by the treatment liquid cap in the first uncapped state;
a pump connected to the outlet port of the switching valve; and
a controller,
wherein the controller is configured to execute:
a first covering process of causing the first switching mechanism to cover the treatment liquid nozzle surface with the treatment liquid cap;
a treatment liquid-purging process of activating the pump to discharge the pre-treatment liquid from the treatment liquid nozzle holes to the treatment liquid cap;
a first liquid-draining process of causing the channel switching mechanism to connect the first liquid-draining channel to the outlet port and of activating the pump to drain the pre-treatment liquid, discharged to the treatment liquid cap, from the treatment liquid cap via the first liquid-draining channel; and
a first cleaning process of causing the channel switching mechanism to connect the first cleaning liquid-supplying channel to the outlet port and of activating the pump to supply cleaning liquid in the cleaning liquid tank to the treatment liquid cap,
wherein the controller executes the first cleaning process between the treatment liquid-purging process and the first liquid-draining process.

13. A liquid ejecting apparatus comprising:
an ejecting head having a nozzle plate, the nozzle plate having treatment liquid nozzle holes and ink nozzle holes, treatment liquid being ejected from the treatment liquid nozzle holes, ink being ejected from the ink nozzle holes, the treatment liquid including one of pre-treatment liquid, post-treatment liquid, or both the pre-treatment liquid and the post-treatment liquid, the ink including one of white ink, color ink, or both the white ink and the color ink;
a treatment liquid cap, a treatment liquid nozzle surface being covered by the treatment liquid cap, the treatment liquid nozzle surface being a surface of the nozzle plate, the treatment liquid nozzle holes extending through the treatment liquid nozzle surface;
an ink cap, an ink nozzle surface being covered by the ink cap, the ink nozzle surface being the surface of the nozzle plate, the ink nozzle holes extending through the ink nozzle surface;
a cleaning liquid tank;
a plurality of channels; and
a channel switching mechanism including a switching valve having an outlet port and a plurality of inlet ports, a channel to be communicated with the outlet port being switched by the channel switching mechanism among the plurality of channels,
wherein the plurality of channels includes:
a first liquid-draining channel connecting the ejecting head and the switching valve, the treatment liquid discharged to the treatment liquid cap flowing through the first liquid-draining channel;
a second liquid-draining channel connecting the ejecting head and the switching valve, the ink discharged to the ink cap flowing through the second liquid-draining channel;
a first cleaning liquid-supplying channel connecting the cleaning liquid tank to the switching valve via the treatment liquid cap;
a second cleaning liquid-supplying channel connecting the cleaning liquid tank to the switching valve via the ink cap; and
a cleaning liquid bypass channel connecting the cleaning liquid tank to the switching valve not via the treatment liquid cap and the ink cap.

14. A liquid ejecting apparatus comprising:
an ejecting head having a nozzle plate, the nozzle plate having treatment liquid nozzle holes and ink nozzle holes, treatment liquid being ejected from the treatment liquid nozzle holes, ink being ejected from the ink nozzle holes, the treatment liquid including one of pre-treatment liquid, post-treatment liquid, or both the pre-treatment liquid and the post-treatment liquid, the ink including one of white ink, color ink, or both the white ink and the color ink;
a cap, a treatment liquid nozzle surface and an ink nozzle surface being covered by the cap, the treatment liquid nozzle surface being a surface of the nozzle plate, the treatment liquid nozzle holes extending through the treatment liquid nozzle surface, the ink nozzle surface being the surface of the nozzle plate, the ink nozzle holes extending through the ink nozzle surface;
a cleaning liquid tank;
a plurality of channels; and
a channel switching mechanism including a switching valve having an outlet port and a plurality of inlet ports, a channel to be communicated with the outlet port being switched by the channel switching mechanism among the plurality of channels,
wherein the plurality of channels includes:
a first liquid-draining channel connecting the ejecting head and the switching valve, the treatment liquid discharged to the cap flowing through the first liquid-draining channel;
a second liquid-draining channel connecting the ejecting and the switching valve, the ink discharged to the cap flowing through the second liquid-draining channel;
a first cleaning liquid-supplying channel connecting the cleaning liquid tank to the switching valve via the cap;
a second cleaning liquid-supplying channel connecting the cleaning liquid tank to the switching valve via the cap; and
a cleaning liquid bypass channel connecting the cleaning liquid tank to the switching valve not via the cap.
